(19) United States
(12) Patent Application Publication
(10) Pub. No.: US 2009/0315611 A1
(43) Pub. Date: Dec. 24, 2009

(54) QUADRATURE MIXER CIRCUIT

(75) Inventor: Eric Chiyuan LU, San Jose, CA (US)

Correspondence Address: SAWYER LAW GROUP PC, 2465 E. Bayshore Road, Suite No. 406, PALO ALTO, CA, 94303, US

(73) Assignee: Ralink Technology Corporation, Cupertino, CA (US)

(21) Appl. No.: 12/145,444

(22) Filed: Jun. 24, 2008

(51) Int. Cl. G06G 7/14

(52) U.S. Cl. 327/361

(57) ABSTRACT

A mixer is disclosed. In one embodiment, the mixer includes a polyphase filter that generates linear quadrature signals. The mixer also includes a potentiometric mixer that performs a frequency-conversion operation on the quadrature signal. According to the embodiments disclosed herein, the output of the potentiometric mixer has high linearity.

### FIELD OF THE INVENTION

The present invention relates to integrated circuits, and more particularly to a mixer utilizing such integrated circuits.

### BACKGROUND OF THE INVENTION

Quadrature mixers are utilized in a wide variety of applications. For example, quadrature mixers may be utilized in communication applications such as wireless networking devices, cellular communications devices, etc. in order to frequency down-convert or up-convert the signal with quadrature(90 degree)-phase-difference inputs or outputs. Typically, a quadrature mixer includes a polyphase filter coupled to a Gilbert cell mixer. The polyphase filter splits an input signal into 90-degree-phase-difference outputs. The Gilbert cell mixer includes an active transconductance stage, which limits linearity in low-voltage applications. The active transconductance stage limits linearity, because voltage signals processes by active circuit elements are limited by the power supply. A problem with low linearity is that voltages swings can be large enough to become clipped or distorted due to the power supply limitations. Clipping or distortion of voltage signals results in poor quality of output signals, which is undesired in applications such as voice communications.

What is needed is an improved quadrature mixer, which operates over a wider linear range than a conventional quadrature mixer. The quadrature mixer should be simple and cost-effective. The present invention addresses such a need.

### SUMMARY OF THE INVENTION

A mixer is disclosed. In one embodiment, the mixer includes a polyphase filter that generates quadrature signals. The mixer also includes a potentiometric mixer that performs a frequency-conversion operation on the quadrature signal. According to the embodiments disclosed herein, the output of the potentiometric mixer has high linearity.

### BRIEF DESCRIPTION OF THE DRAWINGS

FIG. 1 is a block diagram of a quadrature mixer circuit in accordance with one embodiment.

FIG. 2 is a block diagram of a quadrature mixer circuit in accordance with another embodiment.

FIG. 3 is a flow chart showing a method for generating a signal having high linearity in accordance with the present invention.

FIG. 4 is a block diagram of a quadrature mixer circuit in accordance with another embodiment.

FIG. 5 is a block diagram of a quadrature mixer circuit in accordance with another embodiment.

FIG. 6 is a block diagram of a quadrature mixer circuit in accordance with another embodiment.

### DETAILED DESCRIPTION OF THE INVENTION

The present invention relates to computer systems, and more particularly to a mixer. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A mixer is disclosed. In one embodiment, the mixer includes a polyphase filter that generates quadrature signals. The mixer also includes a potentiometric mixer that performs a frequency-conversion operation on the quadrature signals. According to the embodiments disclosed herein, the output of the potentiometric mixer has high linearity. What is meant by having high linearity is that the potentiometric mixer has a high output dynamic range. Being highly linear, the mixer outputs a large range of voltages (e.g., rail-to-rail) in a linear fashion to ensure proper operations. To more particularly describe the features of the present invention, refer now to the following description in conjunction with the accompanying figures.

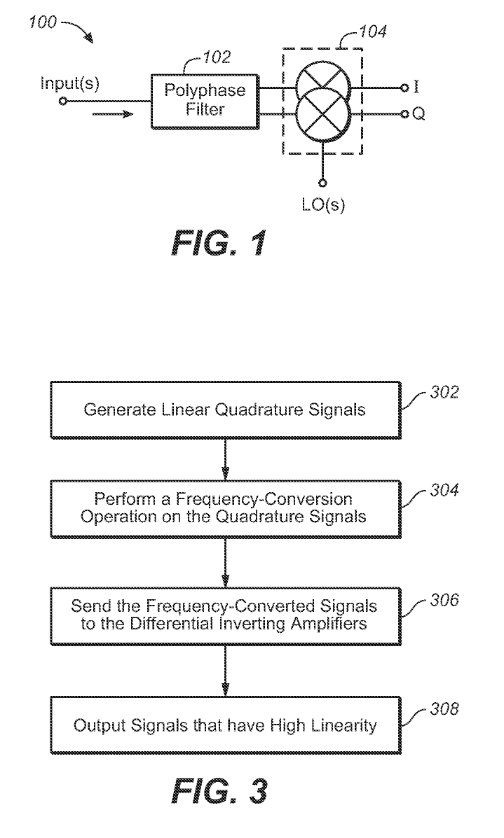

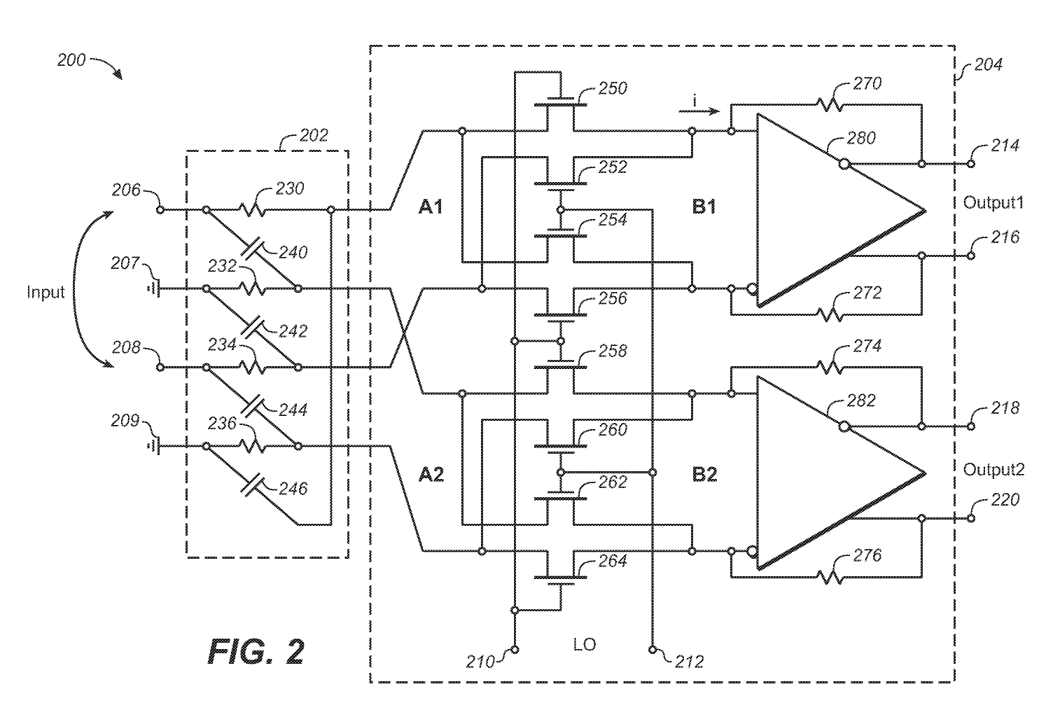

FIG. 1 is a block diagram of a quadrature mixer circuit 100 in accordance with one embodiment. As FIG. 1 shows, the mixer circuit 100 includes a polyphase filter 102 and a potentiometric mixer 104. In one embodiment, the mixer 100 circuit is a cross-coupled differential amplifier. In operation, in one embodiment, the mixer circuit 100 performs general functions (e.g., frequency mixing) of a Gilbert cell mixer, except that the mixer circuit 100 achieves high linearity. The mixer circuit 100 achieves high linearity by combining quadrature signal generation and frequency mixing in a current mode. As described in more detail below, the potentiometric mixer 104 includes an input stage, an intermediate stage, and one or more differential amplifiers. The intermediate stage has only passive elements to allow for current mode operation. As a result of the current mode operation, the differential amplifiers have high input dynamic range and a high output dynamic range. In other words, the different amplifiers of the mixer circuit 100 output a large range of voltages (e.g., rail-to-rail) in a linear fashion to ensure proper operations. More detailed embodiments of the mixer circuit 100 are described below in FIGS. 2-5.

FIG. 2 is a block diagram of a quadrature mixer circuit 200 in accordance with another embodiment. As FIG. 2 shows, the mixer circuit 200 includes a polyphase filter 202 and a potentiometric mixer 204. In one embodiment, the mixer circuit 200 is operable to receive an input signal at input nodes 206 and 208, receive a local oscillator (LO) signal at nodes 210 and 212, output a first output signal at output nodes 214 and 216, and output a second output signal at nodes 218 and 220. Input nodes 207 and 209 are grounded.

In one embodiment, the polyphase filter 202 includes only passive elements. Having only passive elements enables the polyphase filter 202 to output two passive high-linear 90-degree-phase-shifted quadrature signals to the potentiometric mixer 204. In one embodiment, the polyphase filter 202 includes resistors 230, 232, 234, and 236, and includes capacitors 240, 242, 244, and 246. For ease of illustration, the polyphase filter 202 is shown as having one stage. In other embodiments, the polyphase filter 202 may have multiple stages.

In one embodiment, the potentiometric mixer 204 includes transistors 250, 252, 254, 256, 258, 260, 262, and 264, and includes resistors 270, 272, 274, and 276, and includes differential inverting amplifiers 280 and 282. As FIG. 2 shows, the potentiometric mixer 204 includes input stages A1 (e.g., drain terminals of transistors 250-256) and A2 (e.g., drain terminals of transistors 258-264), and intermediate stages B1 (e.g., input nodes of differential inverting amplifier 280) and B2 (e.g., differential inverting amplifier 282).

FIG. 3 is a flow chart showing a method for generating a signal having high linearity in accordance with the present invention. Referring to both FIGS. 2 and 3 together, the process begins in step 302 where the polyphase filter 202 generates linear quadrature signals. More specifically, the polyphase filter 202 receives an input signal at nodes 206 and 208 and generates quadrature signals at the outputs. More specifically, the polyphase filter 202 splits the input signal received at nodes 206 and 208 across input stages A1 (e.g., drain terminals of transistors 250-256) and A2 (e.g., drain terminals of transistors 258-264) of the potentiometric mixer 204. In one embodiment, the split is a 90-degree phase shift. The 90-degree phase shift results in quadrature signals that have a 90-degree phase shift difference between the i channel and the q channel for frequency modulation.

Next, in step 304, the potentiometric mixer 204 performs a frequency-conversion operation on the quadrature signals. More specifically, the potentiometric mixer 204 receives the quadrature signals at input stages A1 and A2 and then utilizes the LO signal received at nodes 210 and 212 to perform a frequency-conversion operation on the quadrature signals. In one embodiment, the frequency-conversion operation is a down-conversion operation. In other words, the potentiometric mixer 204 utilizes the LO signal to down-convert the quadrature signals. In an alternative embodiment, the frequency-conversion operation may be an up-conversion operation, where the potentiometric mixer 204 utilizes the LO signal to up-convert the quadrature signals.

In one embodiment, each of the polyphase filter 202 and the potentiometric mixer 204 may process signals in either a current mode or a voltage mode before the signals reach the inputs nodes of the differential inverting amplifiers 280 and 282 (intermediate stages B1 and B2). As described in more detail below, the potentiometric mixer 204 operates in a current mode beginning at the inputs nodes of the differential inverting amplifiers 280 and 282.

Next, in step 306, at intermediate stages B1 and B2, the potentiometric mixer 204 sends the frequency-converted signals to the differential inverting amplifiers 280 and 282. Next, in step 308, the differential inverting amplifiers 280 and 282 of the potentiometric mixer 204 outputs signals that have high linearity. In one embodiment, the intermediate stages B2 and B2 function as pseudo-grounds of the two differential inverting amplifiers 280 and 282 in that the voltage difference between the input nodes of the differential inverting amplifier 280 is zero. Also, the voltage difference between the input nodes of the differential inverting amplifier and 282 is zero. Accordingly, the output voltage swings of each of the differential inverting amplifiers 280 and 282 are regulated and small (e.g., less than 1 mV), depending on the gain of each of the differential inverting amplifiers 280 and 282. As such, the output signals are mostly in the form of current (V_{OUT}=i×R).

Because the input signal passes through passive circuits between the input nodes 206 and 208 of the polyphase filter 202 and the intermediate stages B1 and B2 of the potentiometric mixer 204, the output voltage swings at the output nodes of the potentiometric mixer 204 is highly linear and are limited only by the output linearity of transimpedance amplifiers (e.g., differential inverting amplifiers 280 and 282), which is rail-to-rail. As described above, the potentiometric mixer 204 operates in a current mode beginning at the input nodes of each of the differential inverting amplifiers 280 and 282. The potentiometric mixer 204 operates in a current mode at stages B1 and B2, because the circuit elements in these stages are passive. This is in contrast to using active circuit elements, which operate in a voltage mode, where the voltages are limited by the power supply. Being limited by the power supply causes low linearity, because voltages swings can be large enough to be clipped or distorted due to the power supply limitations. Even if the voltage signals are not clipped, distorted voltages signals is suboptimal communication applications such as voice communications. Embodiments of the present invention eliminate such problems, because the outputs of the differential inverting amplifiers 280 and 282 are based on current, which is not limited. As such, the differential inverting amplifiers 280 and 282 are highly linear in that they can have higher input dynamic range and a resulting rail-to-rail output. Accordingly, operating in a current mode enables high linearity and thus provides a great advantage.

At the output nodes 214-220 of the each of the differential inverting amplifiers 280 and 282, the current signals are converted to voltage signals with high linearity. The voltage signals at the output of the differential inverting amplifiers 280 and 282 are highly linear, because the input nodes operate in a current mode, where the current is not limited.

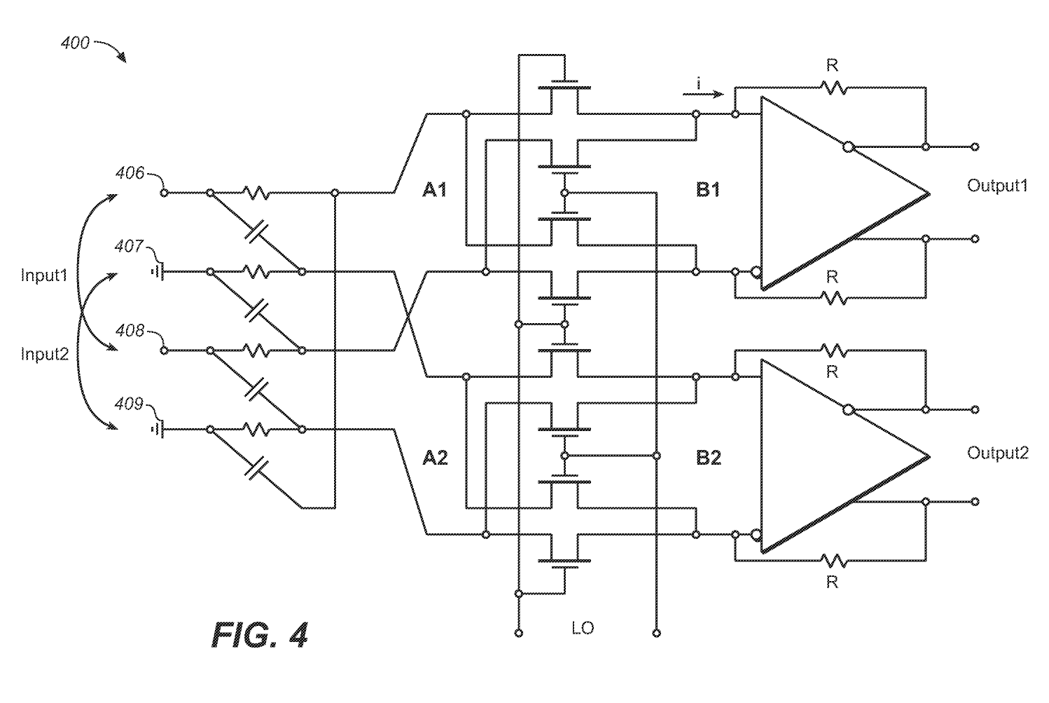

FIGS. 4-6 show variants of the embodiment of FIG. 2. FIG. 4 is a block diagram of a quadrature mixer circuit 400 in accordance with another embodiment. The quadrature mixer circuit 400 is similar to that of FIG. 2 except that the quadrature mixer circuit 400 of FIG. 4 receives two input signals. In one embodiment, one input signal is received at nodes 406 and 408, and one input signal is received at nodes 407 and 409. In one embodiment, the two input signals have the same frequency and have a 90-degree phase difference.

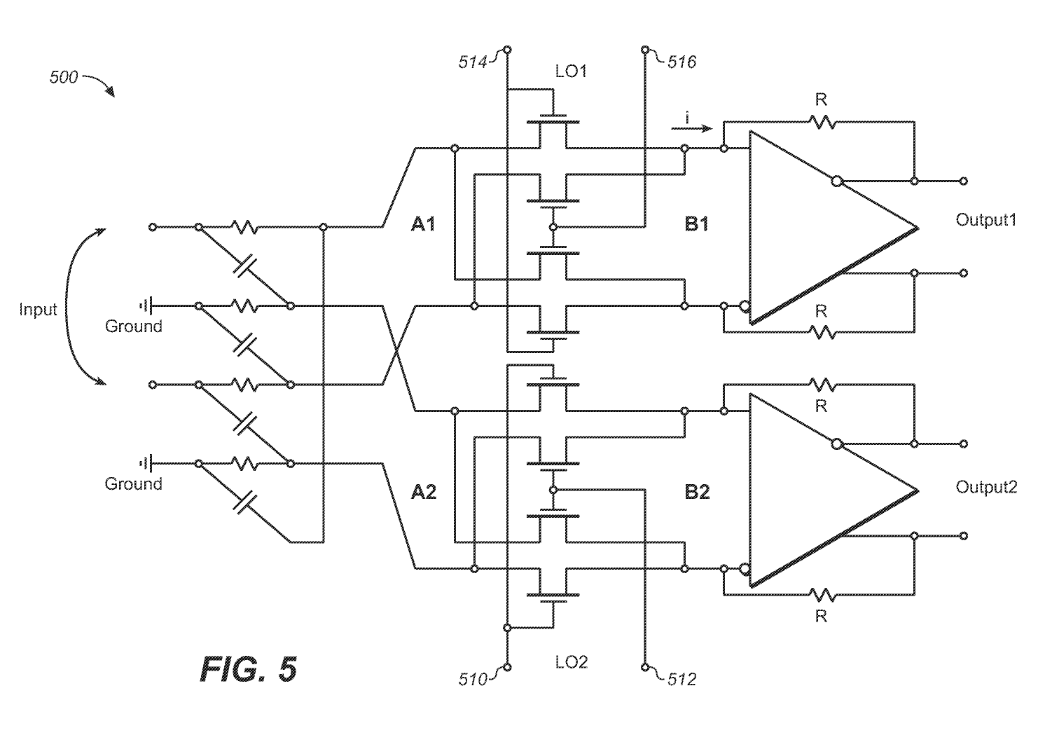

FIG. 5 is a block diagram of a quadrature mixer circuit 500 in accordance with another embodiment. The quadrature mixer circuit 500 is similar to that of FIG. 2 except that the quadrature mixer circuit 500 of FIG. 5 receives two LO signals. In one embodiment, one LO signal is received at nodes 510 and 512 and one LO signal is received at nodes 514 and 516.

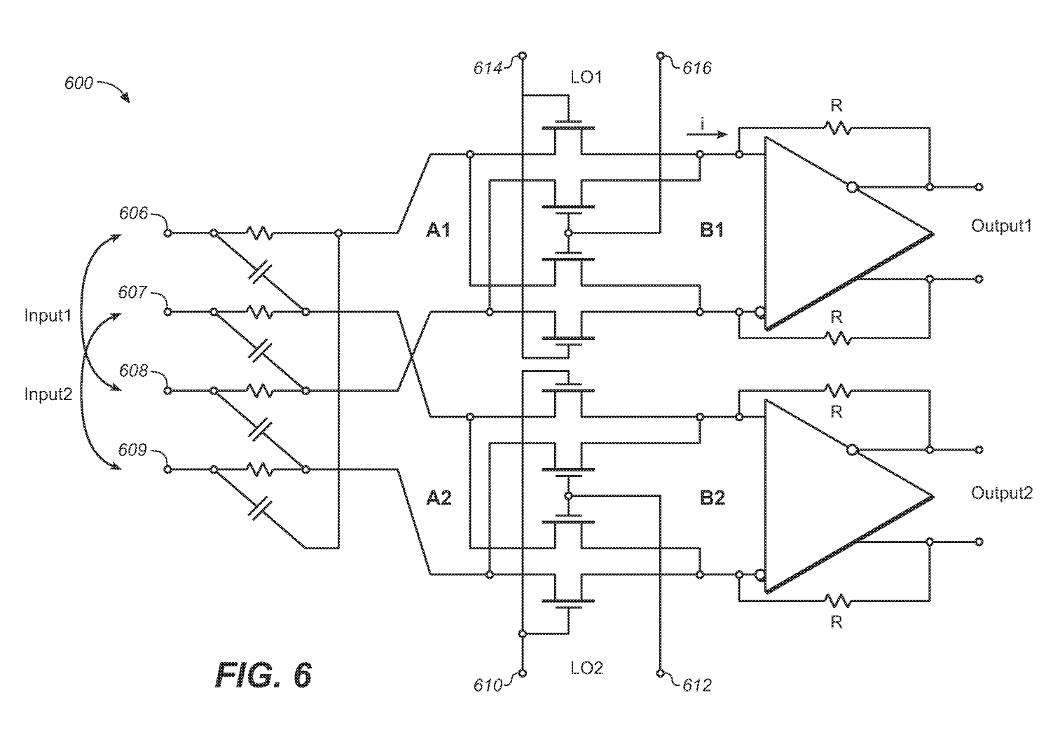

FIG. 6 is a block diagram of a quadrature mixer circuit 600 in accordance with another embodiment. The quadrature mixer circuit 600 is similar to that of FIG. 2 except that the quadrature mixer circuit 600 of FIG. 6 receives two input signals and receives two LO signals. In one embodiment, one input signal is received at nodes 606 and 608 and one input signal is received at nodes 607 and 609. In one embodiment, one LO signal is received at nodes 610 and 612 and one LO signal is received at nodes 614 and 616. In one embodiment, the two input signals have the same frequency and have a 90-degree phase difference.

According to the system and method disclosed herein, the present invention provides numerous benefits. For example, embodiments of the present invention provide high linearity performance. Embodiments of the present invention also achieve quadrature phase generating and frequency mixing at the same time without active transconductance between inputs and outputs.

A mixer has been disclosed. In one embodiment, the mixer includes a polyphase filter that generates linear quadrature signals. The mixer also includes a potentiometric mixer that performs a frequency-conversion operation on the quadrature signals. According to the embodiments disclosed herein, the output of the potentiometric mixer has high linearity.

The present invention has been described in accordance with the embodiments shown. One of ordinary skill in the art will readily recognize that there could be variations to the embodiments, and that any variations would be within the spirit and scope of the present invention. Accordingly, many modifications may be made by one of ordinary skill in the art without departing from the spirit and scope of the appended claims.

1. A circuit comprising:
a polyphase filter that generates linear quadrature signals; and
a mixer circuit, wherein the mixer circuit comprises:
a plurality of transistors coupled to the output of the polyphase filter, wherein the plurality of transistors receive the linear quadrature signals from the polyphase filter and perform a frequency-conversion operation on the quadrature signals; and
at least one differential amplifier coupled to outputs the plurality of transistors, wherein an output of the at least one differential amplifier has high linearity.

2-3. (canceled)

4. The circuit of claim 1 wherein the output voltage swing of the mixer circuit is rail-to-rail.

5. The circuit of claim 1 wherein the polyphase filter passively generates quadrature signals from an input signal and performs a 90-degree split on the input signal.

6. The circuit of claim 1 wherein the frequency-conversion operation is a down-conversion operation.

7. The circuit of claim 1 wherein the output voltage swing of the mixer circuit is limited by the output linearity of the differential amplifier.

8. The circuit of claim 1 wherein the polyphase filter comprises at least two inputs.

9. The circuit of claim 1 wherein the polyphase filter comprises a plurality of inputs.

10. The circuit of claim 1 wherein the mixer circuit comprises at least one LO input.

11. The circuit of claim 1 wherein the mixer circuit comprises a plurality of LO inputs.

12. A method comprising:
generating linear quadrature signals using a polyphase filter; and
performing a frequency-conversion operation on the quadrature signals using a mixer circuit, wherein the mixer circuit comprises a plurality of transistors coupled to the output of the polyphase filter, wherein the plurality of transistors receive the linear quadrature signals from the polyphase filter and perform the frequency-conversion operation on the quadrature signals; and
at least one differential amplifier coupled to outputs the plurality of transistors, wherein an output of the at least one differential amplifier has high linearity.

13-14. (canceled)

15. The method of claim 12 wherein the output voltage swing of the mixer circuit is rail-to-rail.

16. The method of claim 12 wherein the polyphase filter passively generates quadrature signals from an input signal and performs a 90-degree split on the input signal.

17. The method of claim 12 wherein the frequency-conversion operation is a down-conversion operation.

18. The method of claim 12 wherein the output voltage swing of the mixer circuit is limited by the output linearity of the differential amplifier.

19. The method of claim 12 wherein the polyphase filter comprises at least one input.

20. The method of claim 12 wherein the polyphase filter comprises a plurality of inputs.
